(19) United States
(12) Patent Application Publication
(10) Pub. No.: US 2024/0407276 A1
(43) Pub. Date: Dec. 12, 2024

(54) ROTARY WEED REMOVAL TOOL

(71) Applicant: George E. W. MCALLISTER, Fredericton (CA)

(72) Inventor: George E. W. MCALLISTER, Fredericton (CA)

(21) Appl. No.: 18/737,010

(22) Filed: Jun. 7, 2024

Related U.S. Application Data
(60) Provisional application No. 63/472,261, filed on Jun. 9, 2023.

(51) Int. Cl. A01B 1/16; A01B 1/24

(52) U.S. Cl. CPC A01B 1/165; A01B 1/243

(57) ABSTRACT

An apparatus for removing weeds from the ground is described. The apparatus comprises an elongated shaft assembly with a top end attachable to a rotary driver; a helix mounted at a lower end of the elongated shaft, the helix shaped and sized to capture weed root material; and an anchoring structure assembly. The elongated shaft assembly is secured within the anchoring structure assembly and is able to rotate and translate longitudinally with respect to the anchoring structure assembly. The helix, when rotationally driven by the rotary driver, threads into the ground around the weed root material to capture the weed root material for removal from the ground.

### CROSS-REFERENCE TO RELATED APPLICATION

This application claims priority to U.S. provisional patent application No. 63/472,261, filed Jun. 9, 2023, which is incorporated herein by reference in its entirety.

### FIELD OF THE INVENTION

The present invention relates to a weed removal tool or similar device which may be an attachment to a hand held power drill or other rotary driver or tool.

### BACKGROUND OF THE INVENTION

The present invention relates to a weed removal tool or similar device which may be an attachment to a hand held power drill or other rotary driver or tool.

Weed removal is an area that employs many approaches. As such, there are numerous types of weed removal tools and methods. These tools consist of varying design and method. Among the various manual tool assist methods, there are main categories which consist of: Manual—with few or no moving parts, Manual—with moving parts, and power assist tools—specifically rotational power.

Manual tools with few or no moving parts are the longest standing used types of weed removal devices. They include but are not limited to small shovels, spades, forks and sickles. Patents include U.S. Pat. Nos. 5,469,923, 5,360,071, 5,207,466, 5,188,340 and 5,060,997. Although these tools can be robust, drawbacks include that significant time and labor is commonly required on the part of the user, and there is often damage to the surrounding area of lawn.

There are also manual weed removal tools or similar devices that rely on a grasping or lever action to grasp and then release the weed. These are designed to manually penetrate the ground and then are manually actuated by the user to grasp and remove the weed and immediate surrounding soil. Patents of these devices include U.S. Pat. Nos. 5,535,833, 5,476,298, 5,154,465, and 4,473,248. One significant drawback of these designs is the strength and effort required by the user to operate the lever action to grasp the weed and surrounding soil.

Known weed pulling devices that penetrate the earth to capture the weed, and then release or eject it are U.S. Pat. Nos. 6,257,346, 8,613,326 and 5,234,241 and 7,845,696. These devices are operated by placing them over the weed and then while pressing down they utilize spikes, blades or shaped fingers to penetrate the ground and grasp the weed and root structure. They are then able to release the weed once it is pulled from the ground. Usually, ejecting happens through use of a plunger or opening their grip on the weed or both. Although easier to use than other manual weed removing devices, these types of weed removal devices still have drawbacks of somewhat significant manual effort of actively using both one's hands and feet to work the device. And they are not ideal in terms of overall time to operate. Furthermore, the nature of the landscape or hardness of the terrain could cause difficulty in successful use of these devices.

Additionally, there are drill and otherwise powered weeding tools that utilize rotating movement such as pronged twisters. Examples of such devices are shown in U.S. Pat. Nos. 6,722,444, 10,327,371, and 5,330,010, 8,813,862. Even though this type of tool employs the ease of using a handheld drill or internal power, they have drawbacks in that they either cannot be relied upon to capture the root effectively, or the plant could simply break off and leave the root. Further drawbacks include lack of stability and precision available to the user which can result in damage to the surrounding lawn.

Considering the foregoing, there is a need for a more precise and efficient system and method to remove weeds, one which is more convenient and time saving in nature, and has greater ease of use.

### SUMMARY OF THE INVENTION

It is an object of the present invention to provide an improved system and method for removing weeds that obviates or mitigates at least one disadvantage of the prior art. Advantages of the present invention over prior art may include efficiency, precision, speed, self-anchoring function, works through the full cycle with the user operating the rotary driver in one direction, collecting the root material by a singular helix, automatically returns to the starting configuration, soil aeration, fully automatic-touch of a button-use, one handed operation.

In an aspect of the present invention, there is provided an apparatus that is a device to remove weeds which is an attachment to, and is powered by a rotary driver, said apparatus can be used to effectively remove the weed and root from the soil in a precise and timely manner. The apparatus comprises a shaft assembly, which on the upper end is the attachment point to the power source which is usually, but not limited to, a hand held power rotary driver, and on the lower end it is mounted to an open ended helix. The helix threads into the soil and captures and uproots the weed and root material. The process will simultaneously create soil aeration.

Additionally, the apparatus comprises an anchoring structure assembly. The anchoring structure assembly is attached to the shaft assembly such that it allows the shaft assembly to rotate freely and allows the shaft assembly to move back and forth longitudinally within a set distance, while the anchoring structure assembly can remain rotationally and otherwise stationary. The anchoring structure assembly incorporates one or more anchoring claws, which may number three, that lightly penetrate the soil to create a locational anchor in order to provide stability and precision during use of said apparatus. A biasing element, such as a coil spring, provides force for said apparatus to return to or stay in the starting configuration by pushing the shaft assembly longitudinally from the anchoring structure assembly toward and into the starting configuration of said apparatus. When said apparatus is engaged to start the usage cycle such that the helix threads into the soil, collecting the weed and root material, the coil spring compresses as the helix extends into the soil until the apparatus reaches the fully extended configuration. The longitudinal force load between the shaft assembly and the anchoring structure assembly also maintains constant ground anchoring contact by the anchoring claws of the anchoring structure assembly for precision during use through both entry of the helix into the soil when it encompasses the weed root and upon exit from the soil once the weed root has been uprooted.

Furthermore, the apparatus is configured such that operation takes place within set longitudinal slide parameters between the shaft assembly and the anchoring structure assembly. These parameters make effective use and ease of use possible by utilizing the force load from the biasing element such that the apparatus automatically returns to the starting configuration. This maintains ground contact by the claws of the anchoring structure assembly, and prohibits the helix from extending too far into the soil during use. The starting configuration allows for the weed to be successfully targeted as the operator is easily able to aim the lower open end of the main cylinder of the apparatus over the base of the weed to be removed, while ground anchoring is simultaneously initiated as the claws on the anchoring structure assembly lightly penetrate the soil for stability. Once the rotary driver is driven (e.g., in the standard forward direction), the attached apparatus is engaged to begin to capture the weed and root by threading into the soil and encompassing the weed and root. The rotational force exerted from the rotary driver, and the grip force as the helix threads into the soil is enough to momentarily overpower the force exerted by the biasing element between the shaft assembly and the anchoring structure assembly. Once the helix has reached the fully extended configuration and has rotated enough to separate the root material and a small amount of soil, so that the helix is no longer maintaining a threaded grip, the apparatus will then return to its starting configuration as the operator lifts up the rotary driver and apparatus. Furthermore, the set longitudinal slide of the apparatus will permit the helix to extend into the soil to the pre-set depth maximum, but will prohibit the helix from overextending into the soil. Thus, in an aspect of the present invention, the user may rely on the tool not inserting too far into the soil during use.

In an aspect of the present invention, there is provided a means and method for the operator to maintain a continual forward rotary driver operation during the normal usage cycle of said apparatus. Once the weed and root capturing helix has extended into the soil to the apparatus' fully extended configuration, the operator can choose to keep the rotary driver rotating and begin to slightly lift the rotary driver and attached apparatus up allowing the helix to retract back up into the anchoring structure assembly and up from the soil into the apparatus starting configuration. While the rotary driver and apparatus is being lifted, the shaft assembly continues rotating, and the helix will continue to work any weed, root material and soil that is remaining in the helix, from the bottom, up through the main cylinder area to exit through the openings in the separator guides. This occurs as long as the rotary driver is engaged in the forward setting and the anchor claws are against the soil or lightly penetrating the soil. While the user lifts to remove the apparatus helix from the soil, the force load from the biasing element pushes the apparatus back into its starting configuration. Once the helix is retracted completely from the soil, the user stops the rotary driver from rotating. The process takes just a few seconds. Thus, the apparatus' weed and root removal process permits the user great ease of use.

In an aspect of the present invention, as the helix rotates, it captures the weed and root material from the soil, and works it up through the main cylinder and then ejects the weed and root material through the openings in the separator guides. As the helix returns to its starting configuration, the separator guides assist in the function of separating the weed, root material and any captured soil from the helix dispersing it onto the ground surface.

In an aspect of the present invention, the apparatus will separate some of the captured soil from the root material during use. Thus, creating the advantage of the user further caring for the lawn by minimizing the amount of soil lost.

In an aspect of the present invention, the apparatus can be used as a tool to create individual lawn aeration holes.

Thus, the present invention provides an easier and more efficient, and more convenient system and method to remove weeds, one which is efficient and time saving in nature, and has greater ease of use including ergonomic considerations. These and other features and advantages of the present invention are described more fully below.

### BRIEF DESCRIPTION OF THE DRAWINGS

Preferred embodiments of the present invention will now be described, by way of example only, with reference to the attached Figures, wherein:

FIG. 1 is a Perspective view of an apparatus according to the present invention in a starting configuration.

FIG. 2A is a Front view of apparatus of FIG. 1 in a starting configuration.

FIG. 2B is a Top view of apparatus of FIG. 1 in a starting configuration.

FIG. 3A is a Perspective view of anchoring structure assembly of FIG. 1.

FIG. 3B is an Exploded view of anchoring structure assembly of FIG. 1.

FIG. 4A is a Front view of shaft assembly of FIG. 1.

FIG. 4B is an Exploded view of shaft assembly of FIG. 1.

FIG. 5A is a Section view of apparatus of FIG. 1 in a starting configuration.

FIG. 5B is a Partially exploded, front view of FIG. 1 in a starting configuration.

FIG. 6A is a Section view of apparatus of FIG. 1 in an extended configuration.

FIG. 6B is a Partially exploded, front view of apparatus of FIG. 1 in an extended configuration.

### DETAILED DESCRIPTION OF THE INVENTION

The present invention relates to a weed removal tool or similar device which may be provided as an attachment to a rotary driver, such as hand held power drill or similar tool or apparatus. The present invention is quick, efficient, and easy for the user to operate. More particularly, the present invention relates to a self-anchoring, rotational functioning, weed and root material extracting device, which can be utilized by attachment to a rotary driver and then operating the rotary drive in one direction for the complete usage cycle. In other examples, the weed removal tool may be integral with its rotary driver. Although many embodiments are contemplated, the examples discussed herein will be limited to embodiments attachable to a hand held power drill for sake of brevity and clarity.

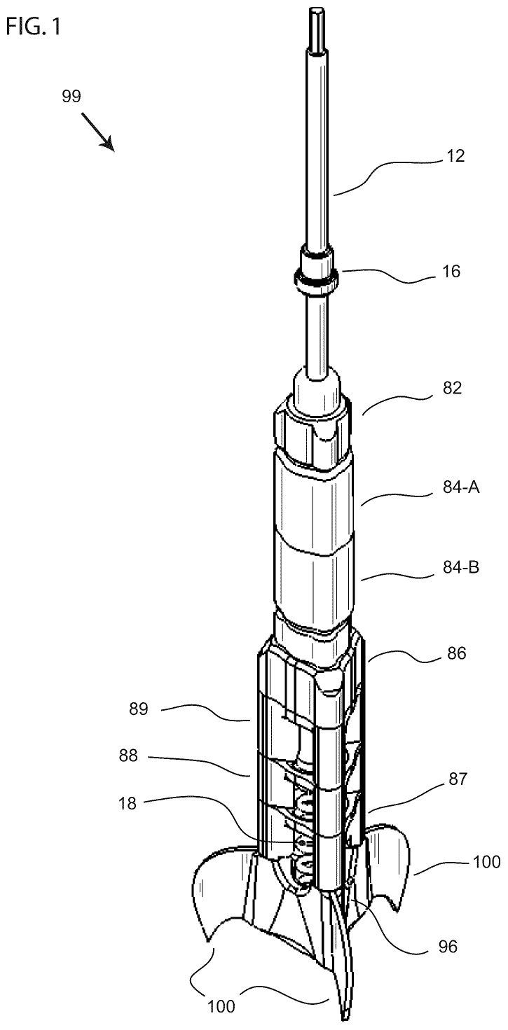

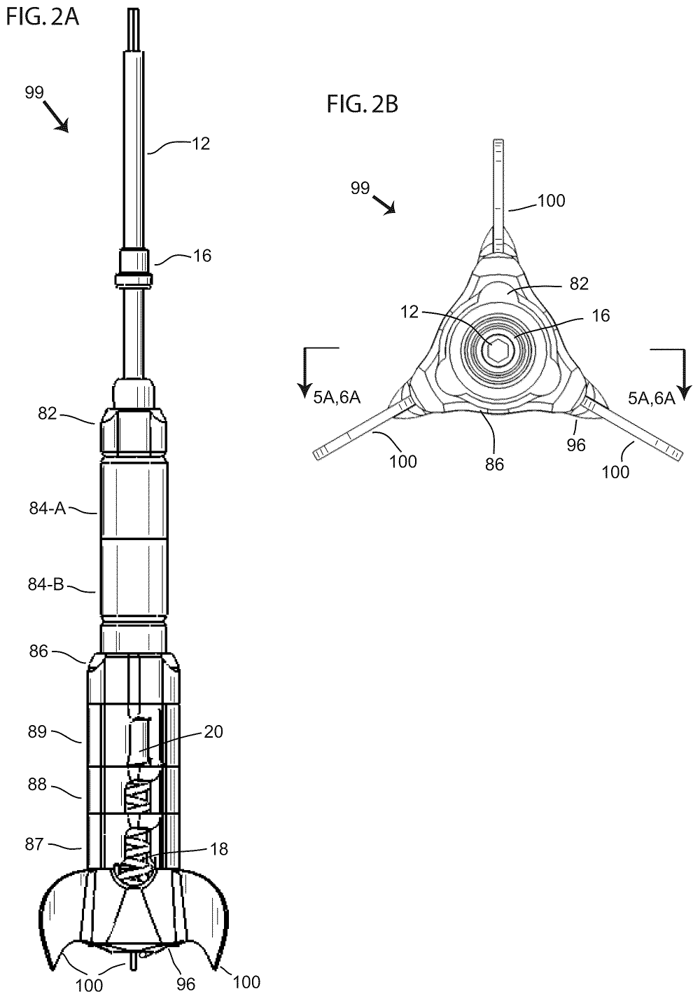

As shown in FIGS. 1, 3A and 4A a preferred embodiment of apparatus 99 includes as main components an elongated shaft assembly 10 which at the topmost is the connection point to a rotary driver. Shaft assembly 10 then extends longitudinally down and then down through the top center of anchoring structure assembly 60 and continues downward with the bottommost part of shaft assembly 10 ending nearly flush, but preferably just beyond the bottommost part of bottom housing bracket 96 of anchoring structure assembly 60.

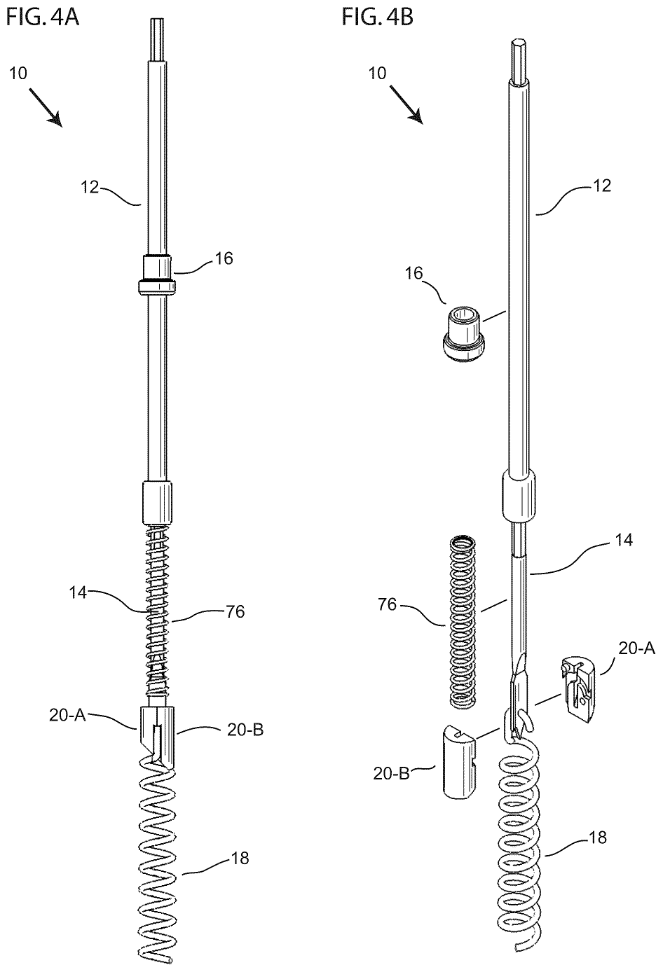

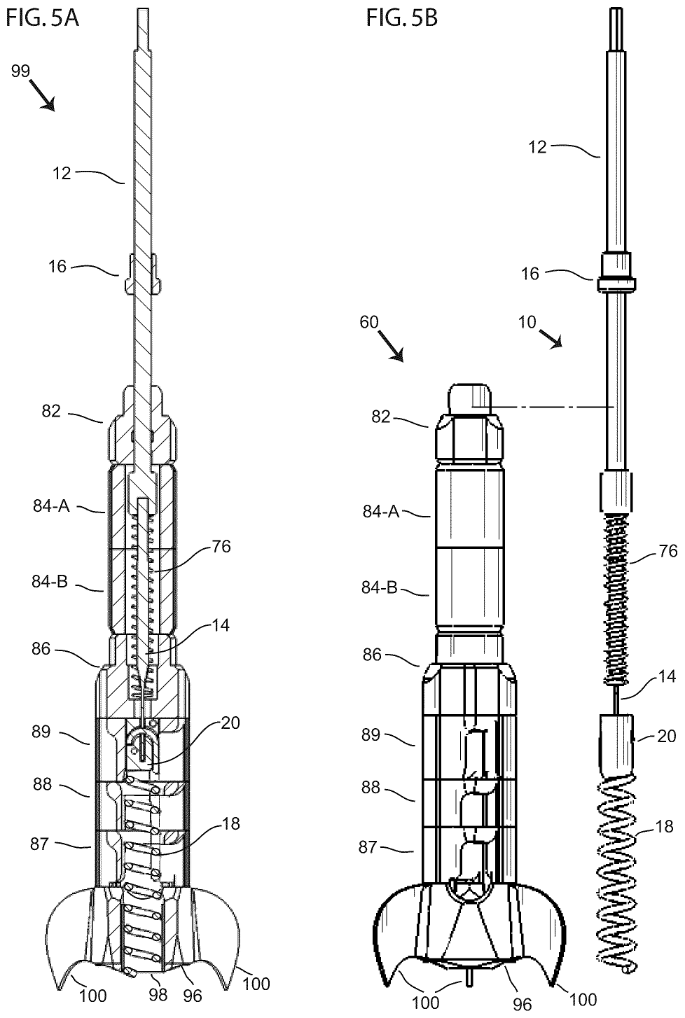

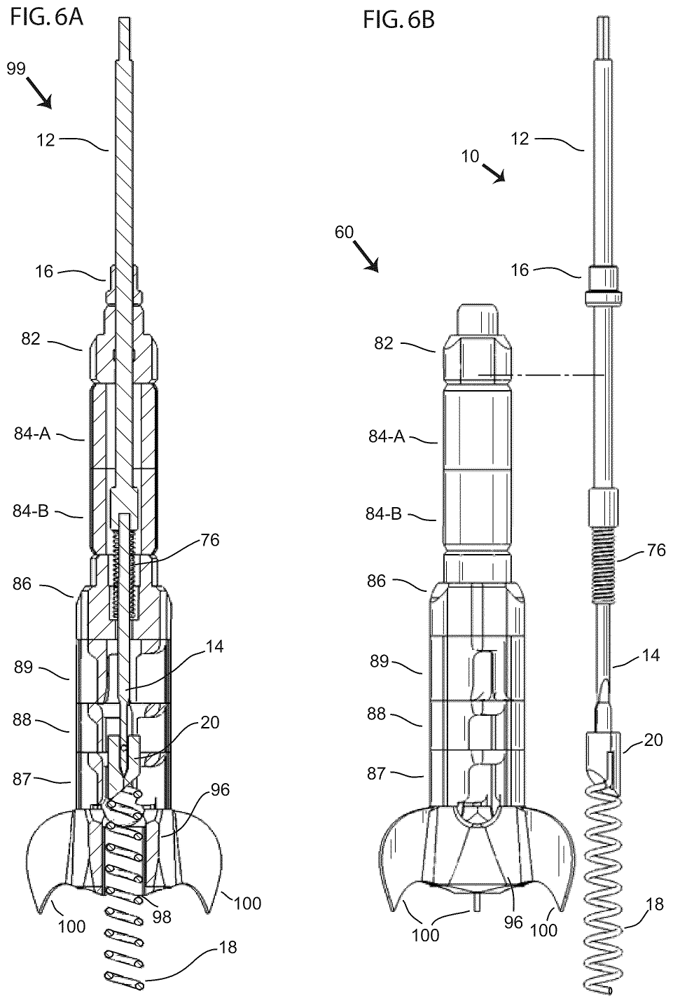

Referring now to FIGS. 4A and 4B, shaft assembly 10 includes shaft 12, which has an upper end that is to be attached to a rotary driver, and has a lower end that is securely attached to the upper end of shaft component 14. The lower end of shaft component 14 is securely attached to the upper part of helix 18 and helix guide 20. Helix guide 20 consists of parts helix guide 20-A and 20-B which fit securely together over the connection point area of shaft component 14 and helix 18. Shaft stopper 16 is securely attached to shaft 12 such that shaft stopper 16 acts as a stopper against the topmost surface of top housing bracket 82 when apparatus 99 has reached its fully downwardly extended configuration, as per FIG. 6A. Helix guide 20, is attached to the bottom of shaft component 14 and the top of helix 18 such that it adds stability and acts as the stopping point for upwards retraction of shaft assembly 10 into anchoring structure assembly 60 which is apparatus's 99 starting configuration as per FIG. 5A.

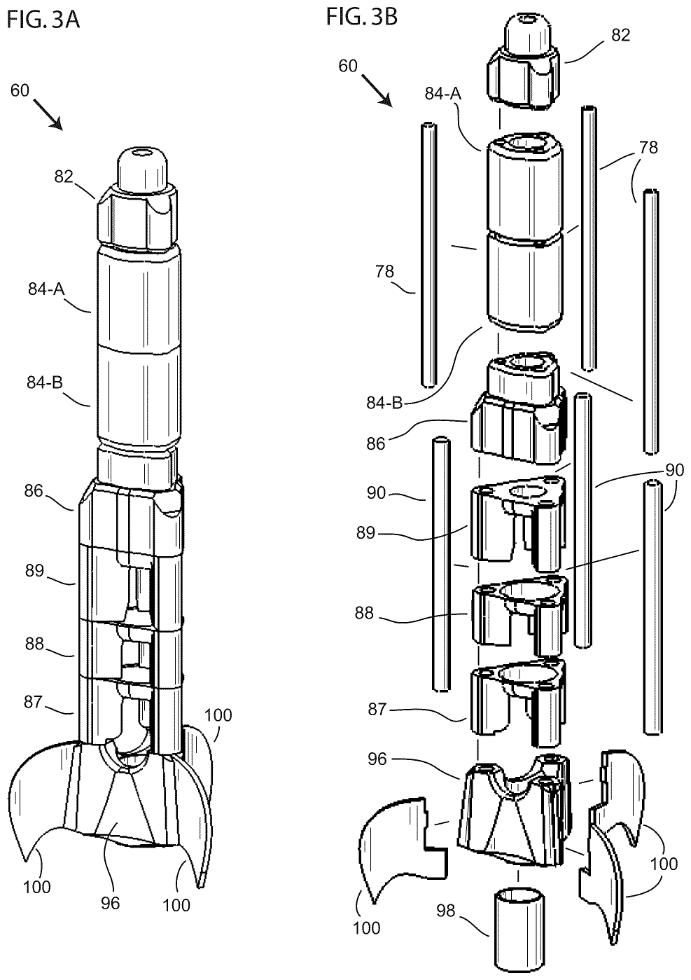

Referring now to FIGS. 3A and 3B, it can be seen that top housing bracket 82 is the uppermost part of anchoring structure assembly 60. Extending down from top housing bracket 82, three upper joining rods 78 are equally spaced, equidistant from center and extend down from and are securely attached into top housing bracket 82 of anchoring structure assembly 60. Upper joining rods 78 then extend down through corresponding vertically oriented circular openings in cover bracket 84 and extend further down into and are securely attached to middle housing bracket 86. Cover bracket 84 may consist of an upper half 84-A and lower half 84-B.

Three lower joining rods 90 are equally spaced from each other, equidistant from center and extend down from and are securely attached into the bottom of middle housing bracket 86. Lower joining rods 90 then extend down through corresponding circular holes in separator guide 89, then separator guide 88, and then separator guide 87 and extend down into and are securely attached to bottom housing bracket 96.

Main cylinder 98 is securely attached to the inner circular opening of bottom housing bracket 96, extending from the upper portion of bottom housing bracket 96 down through to the lowermost portion of bottom housing bracket 96. The inside part of each of the three anchoring claws 100 fit into and are securely attached into the outer three vertical slots of bottom housing bracket 96. Anchoring claws 100 are spaced equidistantly and at 120-degree angles from each other, and extend outwards from bottom housing bracket 96. The outer most part of anchoring claws 100 extend downward and to a point to be the lowest points of anchoring structure assembly 60.

Note that components described herein by number and as equidistant from each other may be replaced with other numbers of such components having other spacing. For example, four anchoring claws spaced apart by 90, 80, 90, and 100 degrees would function substantially the same as the three equally spaced anchor claws mentioned above.

Referring now to FIG. 5A, 5B and FIG. 6A, 6B, the top end of the topmost part of a biasing element, such as a coil spring 76, rests against and is locationally held in place but is able to rotate freely with respect to the bottom facing side of the bottommost part of shaft 12. The bottommost part of spring 76 rests against and is locationally held in place by, but turns freely from the top side of the top inside area of middle housing bracket 86 of anchoring structure assembly 60 such that shaft assembly 10 is able to rotate freely with respect to anchoring structure assembly 60. It can be seen that due to the positioning of shaft component 14 as it extends longitudinally through the center of spring 76, shaft component 14 will act as a guide to maintain spring 76 in position and alignment and prevent it from becoming dislodged or buckling when rotating and when spring 76 is compressed and decompressed.

In an aspect of the present invention, the outside diameter of spring 76 is encompassed by cover bracket 84 which has an inner cylindrical opening which is larger than the outer diameter of spring 76. The opening extends down through the top and out through the bottom of cover bracket 84, and serves as a strength bracket and cover for spring 76. The upper end of cover bracket 84 fits against the bottom surface of top housing bracket 82 and then extends downward where the bottom portion fits against the top of middle housing bracket 86. As per FIG. 3B, upper joining rods 78 extend vertically through corresponding close fitting circular openings which extend all the way though cover bracket 84.

Referring again to FIGS. 3B, and 6A In an aspect of the present invention, separator guide 89, separator guide 88, and separator guide 87 are stacked vertically one upon the other and each have similar design functions of providing three vertical blade features which rest near or against the outer diameter of helix 18 and helix guide 20 and have corresponding openings for soil, weed and root material to exit through. Separator guide 89, separator guide 88, and separator guide 87 each have a horizontally oriented closed loop design at topmost portion which rests against the bottom surface of the part immediately above each. Lower joining rods 90 extend through corresponding close fitting circular openings which extend vertically all the way though separator guide 89, separator guide 88, and separator guide 87 holding them securely in place.

Referring again to FIG. 1 and FIGS. 5A and 5B, which is apparatus 99 in the starting configuration, shaft 12 and shaft component 14 of shaft assembly 10 are held in longitudinal alignment by anchoring structure assembly 60, and are able to turn freely from anchoring structure assembly 60, while also maintaining the ability to move longitudinally within a set distance.

Referring again to FIG. 5A and FIG. 6A, shaft assembly 10 and anchoring structure 60 are connected by low friction, close tolerance fits. The lower portion of shaft 12 extends through the center of top housing bracket 82 and has at least two such fits in the aforementioned; low friction, close tolerance manner, as does the lower portion of shaft component 14 where it extends through the lower center opening of middle housing bracket 86.

Referring again to FIG. 1 and FIG. 5A, the starting configuration as shown is achieved and maintained by the force load applied by spring 76 between shaft assembly 10 and anchoring structure assembly 60. The outer diameter of the top of Helix guide 20 of shaft assembly 10 is larger than the diameter of the center opening at the bottom of middle housing bracket 82 and this determines the stopping point of retraction of shaft assembly 10 up through anchoring structure assembly 60. This comprises the starting configuration of apparatus 99.

Referring now to FIGS. 6A and 6B, it can be seen that as apparatus 99 is in fully extended configuration, the placement of shaft stopper 16 on shaft 12 is the determining factor of the limit of the set longitudinal extension movement between shaft assembly 10 and anchoring structure assembly 60. It can be seen that as apparatus 99 is in its extended configuration, the set limit for extension is reached when the bottom surface of shaft stopper 16 comes against the top of topmost surface of top housing bracket 82. At this point helix 18 has reached maximum depth into the soil. It can also be seen that when apparatus 99 is fully extended, the upper portion of helix 18 remains extending through and above main cylinder 98.

The parameters of the set longitudinal distance that shaft assembly 10 can travel in comparison to anchoring structure assembly 60 are determined, in one direction, by the starting configuration which is the apparatus 99 fully retracted configuration shown in FIGS. 5A and 5B and in the opposite direction by the parameter of apparatus 99 fully extended configuration as shown in FIGS. 6A and 6B.

Construction of apparatus 99 could feasibly be from metal and/or plastic and/or a mix of these and other construction materials and fastening materials and methods. Additionally, the shape, size and number of claws, rods, connectors or other parts, variations of parts and/or features could be adjusted or altered and still be within the scope and claims of said invention. It will also be recognized that other attachment means and materials could be used, as well as an alternate type of rotary powering device. Furthermore, the apparatus' powering device may be fully integrated as part of apparatus 99.

### Operation

With the foregoing construction of apparatus 99 having been fully described, the manner of operation of apparatus 99 will now be explained with reference to FIG. 5A, 5B and FIG. 6A, 6B. The topmost part of shaft 10 of apparatus 99 is to be attached to a rotary driver using the standard rotary driver chuck to rotary driver attachment connection method. Next, with apparatus 99 securely attached to rotary driver, with the operator using one or both hands on the rotary driver, apparatus 99 is positioned over the center of weed and placed such that the bottom end of main cylinder 98 of anchoring structure assembly 60 is positioned directly over the base of the weed to be removed. It can be seen that apparatus 99 is in its starting configuration as per FIGS. 5A and 5B. As apparatus 99 is set down over weed, anchoring claws 100 contact the soil. The user then engages rotary driver in the standard forward direction. Helix 18 immediately begins to thread into the soil and anchoring claws 100 will simultaneously lightly, but securely penetrate the soil serving as a locational anchor during the full usage function of apparatus 99. As anchoring claws 100 of anchoring structure assembly 60 penetrate the soil, anchoring structure assembly 60 thus provides stability and precision while helix 18 of shaft assembly 10 threads into the soil encompassing and capturing the weed and root. Helix 18 will thread into soil until helix 18 of apparatus 99 reaches its fully extended configuration as per FIGS. 6A and 6B. It can be seen that while helix 18 threads into the soil, the widened circular flange area of the bottom most surface of shaft 12 moves down against the top of spring 76 as shaft assembly 10 moves downwardly, while the bottom end of spring 76 maintains its positioning against the upper surface of middle housing bracket 86, causing spring 76 to compress. The fully extended configuration of apparatus 99 is reached when the bottom surface of shaft stopper 16 makes contact with the uppermost surface of top housing bracket 82. This contact causes the extension of shaft assembly 10 in comparison to anchoring structure assembly 60 to stop, while shaft assembly 10 will continue to rotate freely while the operator continues the hand rotary driver to function in the standard forward direction.

At this point of the usage cycle, once Apparatus 99 reaches its fully extended configuration as per FIGS. 6A and 6B, the operator will continue operating the rotary driver in the forward direction. With helix 18 continuing to rotate, the weed including root structure and some soil which helix 18 has captured while extending into the soil, will be worked up through the inside of main cylinder 98, and exit out through the openings in separator guide 87, separator guide 88 and separator guide 89. Advantageously, soil primarily exits first through the openings in separator guide 87 and returns to the ground surface. While weed and root material exits primarily through the openings in separator guide 88 and separator guide 89.

The operator will then begin to lift the rotary driver and attached apparatus 99 up from the soil. While continuing to operate the rotary driver in the forward direction. As the operator lifts, the force of spring 76 causes anchoring structure assembly 60 to maintain its anchor connection in the soil, and apparatus 99 begins to retract towards its starting configuration.

Additionally, as helix 18 and helix guide 20 are rotating and retracting, separator guide 87, separator guide 88 and separator guide 89 function to separate remaining soil, weed and root material from helix 18 and apparatus 99.

Once the operator has lifted rotary driver and apparatus 99 enough that helix 18 has retracted to now be above the surface of soil and apparatus 99 has reached its starting configuration, the operation cycle is complete, and the operator will disengage the rotary driver.

The full usage cycle of apparatus 99 is completed with the rotary driver functioning in the standard forward direction. It is quick and easy for the operator. The entire cycle for each weed removal takes only a few seconds.

A preferred material for helix 18 is spring steel, although through engineering testing, another material may prove to be as effective for strength, which is an important criteria. Helix 18 preferred material thickness range is between 0.10 inches and 0.22 inches. The preferred maximum outer diameter of helix 18 is 0.9 inches. In an aspect of the present invention, helix 18 may have a gradually or systematically increasing or varying helical thread pattern and pitch in order to more effectively capture, raise and release the weed and root material. For example, a helix 18 that has a greater pitch (larger spacing between turns) near the top may move the weed and root material more quickly and efficiently through to exit through the openings in Separator guides 89, 88 and 87 above main cylinder 98. Additionally, the closeness of the tolerance fit between the outer diameter of both helix 18 and helix guide 20 with the design of the vertical blade features of separator guides 89, 88 and 87 allow for and promote successful exit of soil, weed and root material from helix 18 and apparatus 99. In a manner that first separates mostly the soil through separator guide 87 when apparatus 99 is at extended configuration, and then as the helix 18 and helix guide 20 return up through the lower portion of anchoring assembly 60 toward the starting configuration, the weed and root material is separated as it returns to the starting configuration. Separator guides 89, 88, and 87 also serve as effective safety guards.

Biasing element of the preferred embodiment is a coil spring 76. Other examples of useful biasing elements include a heavy elastic, an air cylinder or a spring of another type. The coil spring of the preferred embodiment has an inner diameter dimension such that it clears the outer diameter of shaft component 14 while the outside diameter of spring 76 remains inside of cover housing bracket 84. Biasing force from spring 76 should be strong enough to maintain apparatus 99 to starting configuration, however not so strong that it inhibits helix 18 from threading into the soil during use, spring 76 should allow for up to 3 inches in movement of shaft assembly 60.

The operator may periodically, while holding the apparatus 99 with the bottom end up from the ground surface, and by using one hand to grip housing bracket 84, briefly operate the rotary driver in reverse rotation direction in order to clear out any weed and root build up in the helix 18 area.

Numerous characteristics, and advantages of the invention have been described in detail in the foregoing description with reference to the accompanying drawings. However, the disclosure is for a descriptive purpose only and the invention is not limited to the precisely illustrated and described embodiments. For example, the helix size and dimensions could vary, and dimensional adjustments including aesthetic design changes or addition of safety guards or features or any or all of these may be made without departing the scope of the invention. Noting specifically; It is conceivable that it could be designed to function from a powering source utilized in the reverse direction. And it is conceivable that the apparatus could have an integrated power source.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. For convenience, the relative terms used in the application relate to a user holding a firearm with the barrel facing forward as a reference frame. However, spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

In addition, although preferred embodiments for the parts and components of the apparatus have been described above, other strength adding changes or efficiency improving changes could of course be made. These and other changes and modifications may be effected by one skilled in the art without departing from the scope or spirit of the present invention.

1. An apparatus for removing weeds from the ground, comprising:
an elongated shaft assembly with a top end attachable to a rotary driver;
a helix mounted at a lower end of the elongated shaft, the helix shaped and sized to capture weed root material;
an anchoring structure assembly;
wherein the elongated shaft assembly is secured within the anchoring structure assembly and is able to rotate and translate longitudinally with respect to the anchoring structure assembly;
wherein the helix, when rotationally driven by the rotary driver, threads into the ground around the weed root material to capture the weed root material for removal from the ground.

2. The apparatus of claim 1, wherein the rotationally driven helix feeds the captured weed and root material up from the ground.

3. The apparatus of claim 1, wherein the elongated shaft assembly comprises a biasing element that resiliently longitudinally resists the helix threading into the ground, the biasing element to urge the helix to longitudinally retract out of the ground.

4. The apparatus of claim 1, wherein the user may operate the apparatus for its complete usage cycle while continually utilizing the handheld power drill in a single direction (e.g., in the standard forward direction), without any requirement to change the drill's operating direction.

5. The apparatus of claim 1, wherein the elongated shaft assembly is attached to the anchoring structure assembly by a low friction, close tolerance fit, which allows rotation and longitudinal translation of the shaft assembly.

6. The apparatus of claim 1, wherein the apparatus is self-anchoring and has a built-in anchor.

7. The apparatus of claim 1, wherein the anchor structure includes anchor claws and is force loaded to create the consistent anchoring point during use of the apparatus.

8. The apparatus of claim 1, further comprising separator guides to assist in separating the soil and plant material from the helix.

9. The apparatus of claim 1, further comprising a main cylinder that cooperated with the helix to raise the weed and root structure from the ground.

10. The apparatus of claim 1, wherein the apparatus creates a lawn aeration hole.

11. The apparatus of claim 1, wherein the apparatus is removably attachable to and powered by a handheld drill.

12. The apparatus of claim 1, wherein the helix has a gradually or systematically increasing or varying helical thread pattern and pitch.

13. The apparatus of claim 4, wherein the user may for maintenance purposes, periodically operate the apparatus in the opposite rotational direction from the standard rotational direction, to clear out any buildup of weed and root material from the apparatus.
